(19) United States
(12) Patent Application Publication
(10) Pub. No.: US 2013/0307357 A1
(43) Pub. Date: Nov. 21, 2013

(54) Permanent Magnet Motor with a Closed Cooling System

(71) Applicants: Adin Maksumic, Brattvag (NO); Timothy Myers Myers, Newcastle (GB)

(72) Inventors: Adin Maksumic, Brattvag (NO); Timothy Myers Myers, Newcastle (GB)

(21) Appl. No.: 13/876,862

(22) PCT Filed: Sep. 29, 2011
(86) PCT No.: PCT/NO2011/000278

§ 371 Date: May 21, 2013

(30) Foreign Application Priority Data
Sep. 29, 2010 (NO) 20101347

(51) Int. Cl. H02K 9/197; H02K 9/00

(52) U.S. Cl. CPC H02K 9/197; H02K 9/005
USPC 310/54; 310/63

(57) ABSTRACT

An electric, permanent magnet motor (10) is described, where the motor comprises a motor housing (12) with a stator (14) and an internal rotating rotor (16) connected to a central shaft (24), as the rotor (16) is equipped externally with magnets (30) and the stator (14) is internally equipped with coils (32) and that during operation of the motor, the torque is transferred to the central shaft (24) for operation of external equipment. The motor (10) is equipped with a closed cooling system in the form of a rotor cooling system and a stator cooling system, where the closed rotor cooling system comprises an internal fan system in the motor housing (12) and which is arranged to force a cooling agent to flow through an air gap (52) between the rotor (16) and the stator (14), and past one or more heat exchangers (54) inside the motor housing (12), for cooling the cooling agent which shall be forced through the air gap (52) again, and the stator cooling system comprises a cooling jacket (40) in the motor housing (12), and which surrounds the stator (14), as the fluid is forced to flow through the cooling jacket (40) to take up the heat loss from, at least, the stator (14), and where the cooling jacket (40) of the stator cooling system comprises an internal fluid channel (42) for circulation of the fluid.

The present invention relates to an electric, permanent magnet motor, where the motor comprises a motor housing with a stator and an internal rotating rotor connected to a central shaft, as the rotor is equipped externally with magnets and the stator is internally equipped with coils, and that during operation of the motor the torque is transferred to the central shaft for operation of external equipment. The motor is equipped with a closed cooling system in the form of a motor cooling system and a stator cooling system, where the stator cooling system comprises a cooling jacket in the motor housing and which surrounds the stator as the fluid is forced to flow through the cooling jacket to absorb heat loss from at least the stator, and where the cooling jacket of the stator cooling system comprises an internal fluid channel for circulation of the fluid.

For the operation of smaller electrical winches, there are, in the main, two types of motors that are used, firstly permanent magnet motors and secondly series-wound motors. With a permanent magnet motor less electricity is required, while it also generates more heat than a series-wound motor. For that reason the permanent magnet motor has been the most common type for light to medium load winch work, and where it has been possible to take breaks so that the motor can be cooled down.

In recent years permanent magnet motors have also been used for anchor-handling winches, where relatively large loads are being handled. The advantage with using a permanent magnet motor in relation to a standard hydraulically driven winch is, among other things, a considerable reduction in energy consumption. It is also possible to achieve a lower moment of inertia with a permanent magnet motor, which gives a considerable reduction in power variations and which thereby eases the anchor handling operations and other operations where it is important that the load is held motionless above the ocean bed, independent of how the vessel itself moves.

Other advantages with the use of a permanent magnet motor are higher speed and dynamic winch control, low noise level and maximum torque immediately after starting up.

The application areas for a permanent magnet motor that are described in this application can be many, among other as mentioned in connection with anchor-handling operations, but also on fishing vessels in connection with, for example, trawling or other offshore operations.

Permanent magnet motors for use in anchor-handling operations can be sizeable motors with a large diameter and a considerable torque. An example of such motors can be a motor with an outer diameter of 2 m, power consumption of 14 MW and with a nominal torque of 140 kNm.

From prior art, reference is mode to, among others, WO 9917429 A1 which relates to a unit and a method for thermal insulation of a rotating electrical machine encompassing a stator, colled with a high voltage cable and a rotor, whereby the machine provides thermal insulation in the air gap between stator and rotor.

EP 1085643 A2 relates to a permanent magnetic synchronous motor comprising an external rotor, which can be connected to a shaft, and which borders, with a closing flange, a section in which a stator is placed, characterised in that it is equipped with means for internal ventilation. As the rotor is external it will not be possible to arrange a cooling jacket around the stator.

US 2002/0140273 A1 disclose an electric asynchronous motor for driving a shaft, a roll shell or a similar machine element includes an annular rotor and an annular stator. A motor cooling system includes an internal cooling air circuit wherein an air stream flows between the rotor and the motor shall as well as through an annular heat exchanger for transferring heat from the rotor and/or the stator to a cooling liquid. The annular heat exchanger is positioned within the motor's housing in the area of an end face of the rotor. The cooling air stream also passes over blower vanes and at least one annular series of air circulation channels in the annular body of the stator and/or of the rotor with air streams flowing from the one end face to the other end face of the stator and/or of the rotor, so that the cooling air circuit forms an internal toroidal air stream.

WO 2008/113018 A1 shows a cooling system for an electrical machine comprising a stator and an internal rotor where external fans provide air to the air gap between the stator and the rotor via channels that run into the motor. Also shown is a fluid cooling system for the stator.

None of the documents described show a closed and compact cooling system as given in the present application.

An object of the present invention is consequently to provide a permanent magnet motor for use in heavy operations, which has an effective cooling system and has a compact design.

A further object is to provide a permanent magnet motor with a closed cooling system. On board vessels, and in particular anchor-handling vessels that are open aft, use of a closed and internal cooling system will lead to a more compact and closed motor which will lead to increased space sayings and which, not least, counteract the saltwater problems that can arise due to the exposed placing on the vessel.

The above mentioned object are obtained with am electric, permanent magnet motor, where the motor comprises a motor housing with a stator and an internal rotating rotor connected to a central shaft, as the rotor is equipped externally with magnets and the stator is internally equipped with coils, and that during operation of the motor the torque is transferred to the central shaft for operation of external equipment. The motor is equipped with a closed cooling system in the form of a rotor cooling system and a staler cooling system, where the stator cooling system comprises a cooling jacket in the motor housing and which surrounds the staler as the fluid is forced to flow through the cooling jacket to adsorb heat loss from at least the stator, and where the cooling jacket of the stator cooling system comprises an internal fluid channel for circulation of the fluid. The closed rotor cooling system comprises a number of fans placed in the motor housing, and which is arranged to force a cooling agent to flow through an air gap between the rotor and the stator and past one or more heat exchangers inside the motor housing for cooling of the cooling agent which shall be forced through the air gap again.

Alternative embodiments are given in the respective dependent claims.

The cooling agent in the rotor cooling system is preferably a gas and the cooling agent in the stator cooling system can be water and/or glycol.

The fans in the rotor cooling system can be placed in recesses in the motor housing or in one of the end lids of the motor housing and be arranged to draw gas from the inside of the motor housing and to blow the gas further through the air gap between the stator and the rotor.

The rotor ring of the rotor can be equipped with slits and arranged to function as a fan to draw gas through the inside of the motor housing and to blow the gas further through the air gap between the stator and the rotor. Said slits can be equipped with fan blades.

The gas is preferentially forced past the heat exchanger, where the heat exchanger can be in the form of an air/water heat exchanger equipped with cooling ribs or cooling tubes and into the inside of the motor housing. Said cooling ribs or cooling tubes can be arranged inside on a motor housing endplate. Furthermore, the cooling tubes can be wound into a spiral and be equipped with ribs.

The cooling jacket can have an inlet in the bottom of the jacket and possibly an outlet at the top of the jacket, where at least the inlet is connected to a fluid reservoir. The supply of fluid can be made externally by a tubing.

One of the end lids of the motor can comprise a terminal box, as the end lid comprises a recess or a compartment and is equipped with an external cover. Thus the windings on the stator can extend info the terminal box whereby the motor is arranged to be connected to operate at different rated speeds.

The invention also relates to application of an electric, permanent magnet motor as described above for operation of a winch onboard an anchor handling vessel or fishing vessel.

The invention shall now foe explained in more detail with the help of the enclosed figures, in which:

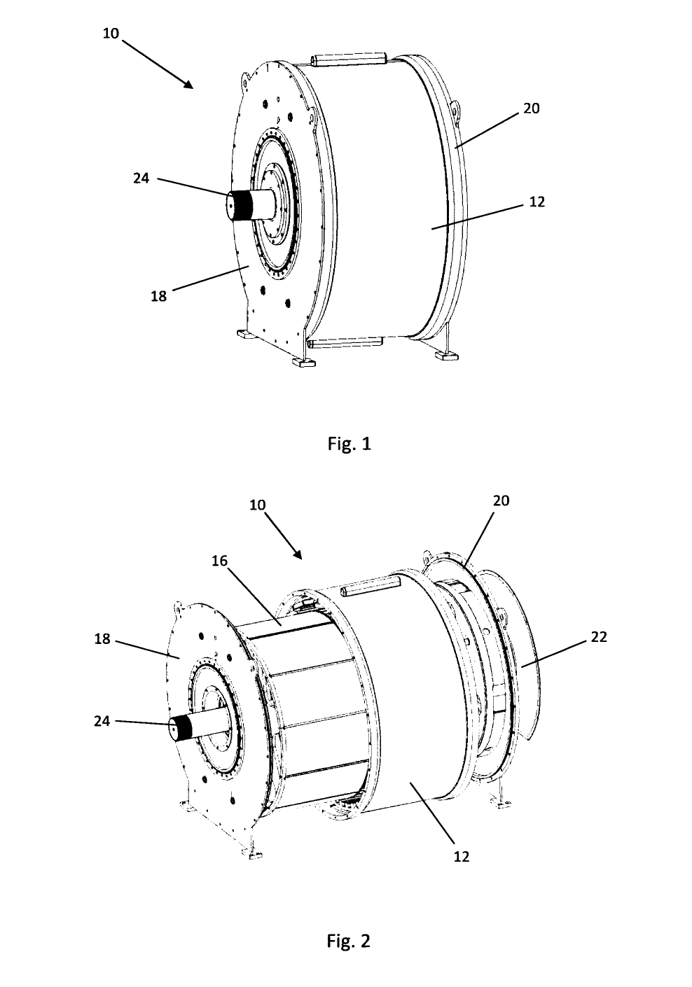

FIG. 1 shows a perspective drawing of a permanent magnet motor according to the invention.

FIG. 2 shows an exploded view of the motor shown in FIG. 1.

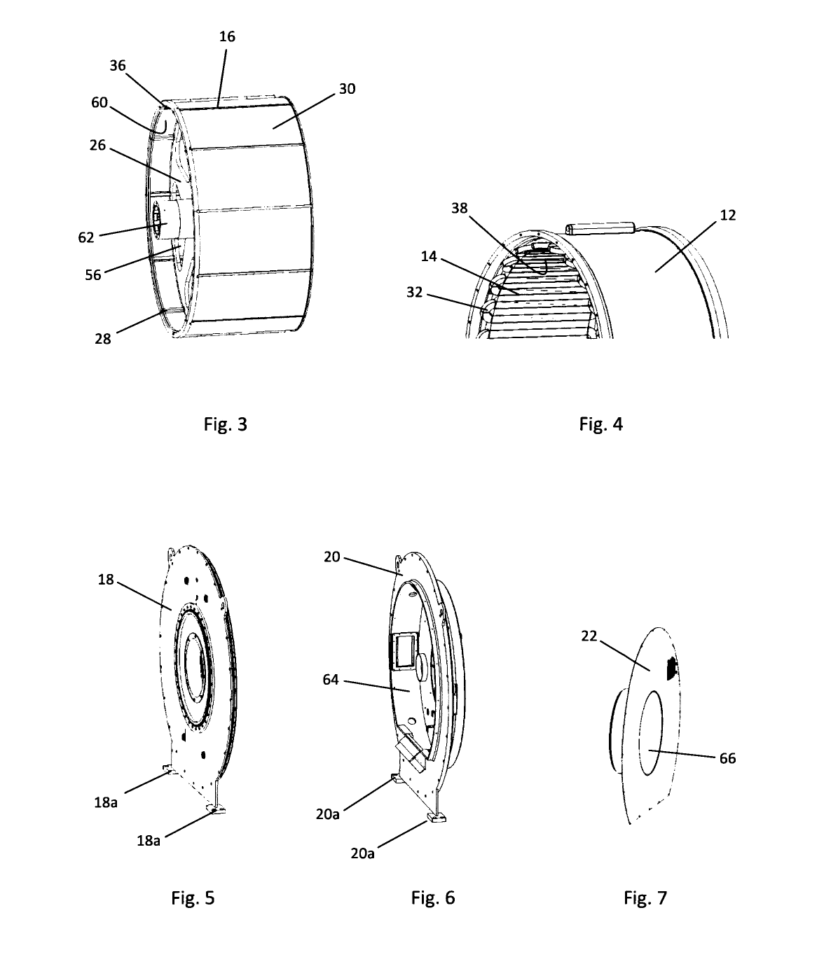

FIGS. 3 and 4 show a rotor and parts of a stator, respectively, which are part of the motor according to the invention.

FIGS. 5, 6 and 7 show end lids for use on the motor according to the invention.

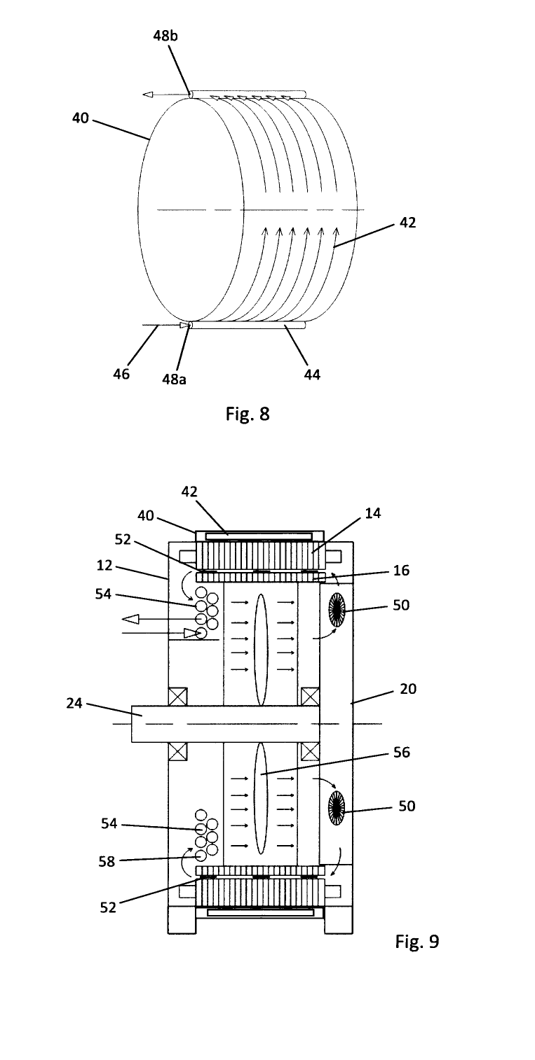

FIG. 8 shows a diagram of a cooling jacket for the stator cooling system according to the invention.

FIG. 9 shows a section of the rotor cooling system according to the invention.

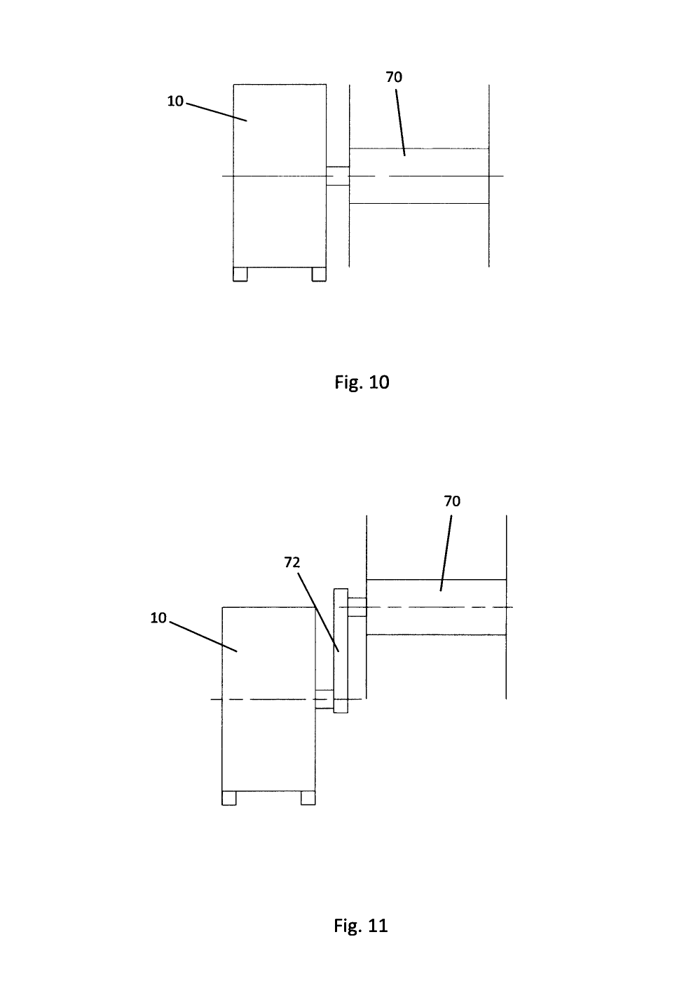

FIGS. 10 and 11 show examples of connection of the motor to a winch system.

The present, permanent magnet motor can, in addition to the equipment that shall be driven, for example, the winch, be connected to a control system that can comprise a control unit and a rectifier and DC transformer so that the motor can be AC frequency controlled. Furthermore the motor can be connected to a monitoring device for monitoring the stator of the motor and the system. A permanent magnet motor is regarded to be known to a person skilled in the art and its detailed construction and mode of operation will not be explained in any detail.

The shaft 24 of the permanent magnet motor can be connected directly to, for example, the drive shaft of a winch, as shown in FIG. 10, or the permanent magnet motor 10 can be connected via a gear transmission 72 to the winch 70 as shown in FIG. 11.

As FIGS. 1 and 2 show, the present, permanent magnet motor 10 comprises a circular-cylindrical motor housing 12 and which is closed by end lids 18 and 20, respectively. The stator 14 of the permanent magnet motor 10 is, in the main, made up of the motor housing 12, as the housing 12 is equipped internally with a stator lamination stack 38 equipped with stator windings 32. The stator lamination stack 38 can be welded or glued to the inside of the motor housing 12.

A rotating rotor 16 is arranged inside the stator 14, where the rotor 16 comprises a rotor ring 26 or spokes, and to which a machined ring 60 or a plate is arranged externally, equipped with a rotor lamination stack supplied with magnets, where the magnets are shown schematically with reference number 30 and the rotor lamination stack is shown schematically with reference number 36.

The rotor lamination stack 38 can be welded or glued to the machined ring 60. Wedges 28 or splints can be arranged between the machined ring 60 and the rotor ring 26 to contribute to transmission of torque during operation of the motor 10. The main object of the rotor ring 26 is to transfer the torque to the shaft 24 connected to the centre of the rotor ring 26, preferably in a fixed hub 62. Furthermore, the magnets can be glued to the rotor lamination stack 36 after the lamination stack is mounted to the rotor ring 26. During operation the rotor 16 is preferably supported on both sides by the end lids 18,20.

One end lid 20 can be equipped with a recess 64, or a compartment, for cables and other equipment and this end lid 20 can therefore be equipped with a cover 22. The cover 22 can be equipped with an internal ring-formed flange 66 through which the shaft 24 runs. The end lid 20 can thereby function as an integrated terminal box 64 for the motor 10 and have inlets for external cables, access openings for the ends 32 of the coils inside the terminal box 64 and flanges for fans that can circulate air inside the motor.

In that the terminal box lies partly inside the motor, a part of the rotor volume is utilised and the advantage with this is that it leads to a compact motor with few protruding parts. Few protruding parts and a compact design are favourable at the installation onboard a vessel because there is limited space available.

Both the end lids 18, 20 can be equipped with ball bearings or other bearings to support the rotor 16 and the shaft 24, and furthermore can be dimensioned to be able to support the whole of the motor 10 on respective legs 18a, 20a.

As mentioned previously, the permanent magnet motor can generate much heat. According to the invention the present, permanent magnet motor is therefore equipped with a closed cooling system, preferably a stator cooling system and a rotor cooling system. These cooling systems can work separately or together.

In the stator cooling system it is preferably intended to use a fluid such as, for example, water, oil or other liquid cooling fluids such as glycol, or an associated mixture. In the rotor cooling system it is preferably intended to use gas, such as, for example, air, helium, argon or other cooling gases.

The stator cooling system can comprise a cooling jacket 40 which is mounted inside the motor housing 12 and which surrounds the stator 14.

FIG. 8 shows a principle diagram of the stator cooling system. A cooling agent for example, water, is supplied externally via a tubing 46 to an inlet 48a and further via one or more channels 42 arranged around the stator 14. A reservoir 44 for the cooling agent can be arranged at the inlet 48a and possibly also at the outlet 48b. The advantages with a reservoir are that it can provide a better flow and that overheated points can be avoided. There can be an inlet at the bottom of the motor and an outlet in the top of the motor, but the channels 42 can also stretch all the way around the stator so that the inlet and outlet are, in the main, at the same place. When the cooling agent circulates in the cooling jacket the excess heat from the stator will be transported away and goes via the stator lamination stack 38 to the fluid channel 42.

The rotor cooling system comprises one, in principle, initially closed fan system. This can be carried out in that the rotor rings 26 of the rotor comprise several slits 56 that function as fans when the rotor goes round, thereby drawing gas into the motor and blowing the gas further. The silts 56 in the rotor 16 can thus be formed as fan blades or be equipped with fan blades to provide more fanning effect.

The fan system can alternatively comprise a number of fans 50 arranged in the motor housing 12 or the end lid 20. Furthermore, the system comprises a heat exchanger 54 arranged at the outlet side of the gas, i.e. as shown in FIG. 9 on the opposite sloe of the fan 50.

The fan 50 or the fans draw a cooling agent, for example, air from the inside of the motor housing 12, through slits 56 in the rotor 16 and forces the air to flow through an air gap 52 which is formed between the rotor 16 and the stator 14. Thereafter the air passes the heat exchanger 54 before it flows further back to the inside of the motor 10. The heat exchanger 54 can be, for example, an air/water heat exchanger and can be equipped with cooling tubes 58. The cooling tubes 58 can be wound in a spiral form and be equipped with ribs to increase the surface area and thus improve the cooling of the air.

The air that passes the air gap 52 will thereby cool the rotor magnets 30 and the associated rotor lamination slack 36 and also the windings 32 of the stator and the associated stator lamination stack 38. Combined with the stator cooling system this provides a unique and effective cooling of the permanent magnet motor 10.

Although a permanent magnet motor is regarded to be known to a person skilled in the art, there are some aspects that shall be pointed out in connection with the present motor. In one embodiment example, the motor can be divided into four parts. Each phase of the motor can comprise two windings that can be connected in parallel, in series or be connected independently of each other. If the winding ends 32 are placed in the terminal box 64, this opens for several possible alternative connections of the windings. The motor 10 can be connected to run at several different speed settings with, for example, 140 kNm as the rated moment. Internal connections in the terminal box 64 can be made with flexible cables of, for example, copper.

Such a motor can fee operated with three times the rated speed, which results in higher speeds than normal. This also leads to that improved cooling of the motor is required, which said cooling systems will provide.

A permanent magnet motor can fee used as described above and earlier in the description, and also, for example, a permanent magnet motor as described in Norwegian patent application 20100525, with application date 13 Apr. 2010, with the content hereby being incorporated by reference, in said patent application, a permanent magnet motor is described for use with lifting devices, and where a safety device is installed which, during reduction in voltages, is arranged to generate a counter moment in the motor to brake the fall of the load. Optionally, one can choose to let the load fall without any counter moment being generated.

1. Electric, permanent magnet motor (10), where the motor comprises a motor housing (12) with a stator (14) and an internal rotating rotor (16) connected to a central shaft (24), as the rotor (16) is equipped externally with magnets (30) and the stator (14) is internally equipped with coils (32) and that dining operation of the motor the torque is transferred to the central shaft (24) for operation of external equipment,
wherein
the motor (10) is equipped with a closed cooling system in the form of a rotor cooling system and a stator cooling system, where
the closed rotor cooling system comprises an internal fan system in the motor housing (12) and which is arranged to force a cooling agent to flow through an air gap (52) between the rotor (16) and the stator (14) and past one or more heat exchangers (54) inside the motor housing (12) for cooling of the cooling agent which shall be forced through the air gap (52) again, and
the stator cooling system comprises a cooling jacket (40) in the motor housing (12) and which surrounds the stator (14) as the fluid is forced to flow through the cooling jacket (40) to absorb heat loss from at least the stator (14), and where the cooling jacket (40) of the stator cooling system comprises an internal fluid channel (42) for circulation of the fluid.

2. Electric, permanent magnet motor (0) according to claim 1,
wherein the cooling agent in the rotor cooling system is a gas and that the cooling agent in the stator cooling system is water and/or glycol.

3. Electric, permanent magnet motor (10) according to claim 2,
wherein the fan system comprises a number of fans (50) placed in the motor housing (12).

4. Electric, permanent magnet motor (10) according to claim 3,
wherein the fans (50) of the rotor cooling system are arranged in recesses in the motor housing (12) or in one of the end lids (20) of the motor housing, and are arranged to draw gas from the inside of the motor housing (12) and to blow the gas further through the air gap (52) between the stator (14) and the rotor (16).

5. Electric, permanent magnet, motor (10) according to claim 2,
wherein the rotor ring (26) of the rotor (16) is equipped with slits (56) that are arranged to function as a fan to draw gas through the inside of the motor housing (12) and to blow gas further through the air gap (52) between the stator (14) and the rotor (16).

6. Electric, permanent magnet motor (10) according to claim 5,
wherein the slits (56) of the rotor (16) are equipped with fan blades.

7. Electric, permanent magnet motor (10) according to claim 3 or 5,
wherein the gas is forced past the heat exchanger (54), where the heat exchanger is in the form of an air/water heat exchanger equipped with cooling ribs or cooling tubes (58), and into the inside of the motor housing (12).

8. Electric, permanent magnet motor (10) according to claim 7,
wherein said cooling ribs or cooling tubes (58) are arranged internally on an endplate of the motor housing (12).

9. Electric, permanent magnet motor (10) according to claim 7,
wherein the cooling tubes (58) are wound in a spiral and equipped with ribs.

10. Electric, permanent magnet motor (10) according to claim 1,
wherein the cooling jacket (40) has an inlet (48a) in the bottom of the jacket and a possible outlet (48b) at the top of the jacket, where, at least, the inlet is connected to a fluid reservoir (44).

11. Electric, permanent magnet motor (10) according to claim 10,
wherein fluid is supplied externally via a tubing (46).

12. Electric, permanent magnet motor (10) according to claim 1,
wherein one of the end lids (20) of the motor (10) comprises a terminal box (64), as the end lid (20) comprises a recess or a compartment and is equipped with an external cover (22).

13. Electric, permanent magnet motor (10) according to claim 12,
wherein the coils (32) of the stator (14) extend into the terminal box (64) whereby the motor (10) is arranged to be connected to run at different speeds.

14. (canceled)

15. A method of using a winch onboard an anchor handling vessel or a fishing vessel comprising using a permanent magnet motor (10), wherein said permanent magnet motor (10) comprises a motor housing (12) with a stator (14) and an internal rotating rotor (16) connected to a central shaft (24), as the rotor (16) is equipped externally with magnets (30) and the stator (14) is internally equipped with coils (32) and that during operation of the motor the torque is transferred to the central shaft (24) for operation of external equipment,
wherein
the motor (10) is equipped with a closed cooling system in the form of a rotor cooling system and a stator cooling system, where
the closed rotor cooling system comprises an internal fan system in the motor housing (12) and which is arranged to force a cooling agent to flow through an air gap (52) between the rotor (16) and the stator (14) and past one or more heat exchangers (54) inside the motor housing (12) for cooling of the cooling agent which shall be forced through the air gap (52) again, and
the stator cooling system comprises a cooling jacket (40) in the motor housing (12) and which surrounds the stator (14) as the fluid is forced to flow through the cooling jacket (40) to absorb heat loss from at least the stator (14), and where the cooling jacket (40) of the stator cooling system comprises an internal fluid channel (42) for circulation of the fluid,
heat loss from at least the stator (14), and where the cooling jacket (40) of the stator cooling system comprises an internal fluid channel (42) for circulation of the fluid.

16. The method of claim 15, wherein the cooling agent in the rotor cooling system is a gas and that the cooling agent in the stator cooling system is water and/or glycol.

17. The method of claim 15, wherein the (an system comprises a number of fans (50) placed in the motor housing (12).

18. The method of claim 15, wherein the fans (50) of the rotor cooling system are arranged in recesses in the motor housing (12) or in one of the end lids (20) of the motor housing, and are arranged to draw gas from the inside of the motor housing (12) and to blow the gas further through the air gap (52) between the stator (14) and the rotor (16).

19. The method of claim 15, wherein the rotor ring (26) of the rotor (16) is equipped with slits (56) that are arranged to function as a fan to draw gas through the inside of the motor housing (12) and to blow gas further through the air gap (52) between the stator (14) and the rotor (16).

20. The method of claim 15, wherein the slits (56) of the rotor (16) are equipped with fan blades.

21. Electric, permanent magnet motor (10) according to claim 8, wherein the cooling tubes (58) are wound in a spiral and equipped with ribs.
